(19) United States
(12) Patent Application Publication
(10) Pub. No.: US 2020/0126697 A1
(43) Pub. Date: Apr. 23, 2020

(54) Method For Obtaining A Material With Giant Magnetocaloric Effect By Ion Irradiation

(71) Applicants: Centre National de la Recherche Scientifique (CNRS), Paris (FR); Sorbonne Universite, Paris (FR)

(72) Inventors: Martino Trassinelli, Paris (FR); Sophie Cervera, Paris (FR); Dominique Vernhet, Le Perreux Sur Marne (FR); Massimiliano Marangolo, Paris (FR); Vincent Garcia, Paris (FR)

(73) Assignees: Centre National de la Recherche Scientifique (CNRS), Paris (FR); Sorbonne Universite, Paris (FR)

(21) Appl. No.: 16/604,761

(22) PCT Filed: Apr. 11, 2018
(86) PCT No.: PCT/EP2018/059324

§ 371 Date: Oct. 11, 2019

(30) Foreign Application Priority Data
Apr. 11, 2017 (FR) 1753170

(51) Int. Cl. H01F 1/01; F25B 21/00; B01J 19/12; H01F 1/00

(52) U.S. Cl. CPC H01F 1/015; F25B 21/00; F25B 2321/002; H01F 1/0009; B01J 19/122

(57) ABSTRACT

The present invention concerns, in particular, a method for obtaining a product with magnetocaloric effect from a single piece of material having a magnetic phase transition, the method comprising irradiation of at least one part of the material with ions, the irradiation being carried out with a suitable flux so that, after the irradiation, the material has various magnetic phase transition temperatures in the various parts of the material.

### FIELD OF THE INVENTION

The present invention relates to the field of magnetocaloric products.

In particular, the invention relates to a method for obtaining such a product.

### STATE OF THE ART

Some materials heat up when placed in a magnetic field and cool when removed from such a magnetic field. This phenomenon is known as the magnetocaloric effect (MCE). MCE-based refrigeration, commonly referred to as ‘magnetic refrigeration’, was first applied in physics at very low temperatures on paramagnetic salts.

The adaptation of this refrigeration technique to ambient temperatures is a major issue because it is environmentally friendly. Magnetic refrigeration could therefore potentially replace gas compression refrigeration, commonly used today in everyday applications.

Different types of thermal cycles can be adopted for magnetic refrigeration. FIG. 1 illustrates an Ericsson thermal cycle for a magnetocaloric material based on isothermal transformations. This cycle moves from a weak magnetic field B1 to a stronger magnetic field B2 while the system is in thermal contact with a hot source at the temperature T_{H} (the temperature of the environment in which the refrigerator is immersed). Heat then passes from the magnetocaloric material to a radiator of the refrigerator, which dissipates this heat into the refrigerator environment. Similarly, when moving from an intense magnetic field B2 to a less intense magnetic field B1 by being in contact with a cold source having a temperature T_{L} (e.g. an internal storage cavity of a refrigerator), heat passes from the cold source to the material. In most food refrigerators, the difference between the temperatures T_{H} and T_{L} is a few tens of degrees.

The cooling power W of a system can be calculated from the magnetic entropy change ΔS(B,T) of the material along the thermal cycle implemented by this system. This value W corresponds to the area of the surface shown in FIG. 1. In other words:

W≈∫_{T}_{_{L}}^{T}^{_{H}}ΔS(B,T)dT

It should be noted that the magnetic entropy change ΔS of a magnetocaloric material is maximum when the material changes magnetic phase. This change occurs near a precise temperature, specific to the material, called the magnetic phase transition temperature.

To be used effectively in everyday applications, a magnetocaloric material must be able to change its temperature within a range of a few tens of degrees around an ambient temperature on Earth. The magnetic phase transition temperature of this material should be within this range.

By way of example, gadolinium is a material with the interesting property that its magnetic phase transition temperature is 290 degrees Kelvin.

In gadolinium, the magnetocaloric effect is associated with the temperature change caused by the order or disorder of the orientation of the elementary magnetic moments of the gadolinium. When a magnetic field is applied, the spins of the atoms align with a decrease in magnetic entropy. If the material is thermally insulated, because the total entropy is preserved (Sₜₒₜ=S_{magn}+S_{network-el}=constant, where S_{magn} is magnetic entropy and S_{network-el} is entropy related to the agitation of atoms and electrons), the material heats up. If the material is in thermal contact with other bodies, to which it can transfer heat, the total entropy of the material decreases. This entropy change is greater at temperatures close to the transition temperature (ferromagnetic-paramagnetic transition in this case).

Gadolinium is a second-order magnetic phase transition material. Second order transitions are those for which the first derivative with respect to one of the thermodynamic variables of free energy is continuous, unlike the second derivative which is discontinuous. This is illustrated in particular by the fact that its magnetisation decreases as a function of its temperature with a relatively small slope.

As a result, the cooling power of any second-order phase transition material, such as gadolinium, is intrinsically limited by this gentle variation of magnetisation. Indeed, the magnetic entropy change of a material induced by the variation of an applied magnetic field is proportional to the derivative of the magnetisation of the material relative to its temperature. The gently sloping nature of the gadolinium magnetisation curve results in a relatively flat entropy change curve as a function of its temperature for the same material, as shown in FIG. 2. Ultimately, the entropy change curve of a second-order phase transition material will always have a low peak height, which limits the value of the integral of this curve, in a temperature interval [T_{L},T_{H}] including the magnetic phase transition temperature of this material, and therefore the cooling power of the material.

It has also been proposed to use other magnetocaloric materials such as iron-rhodium (FeRh) or manganese arsenide (MnAs) which have a first-order transition: the first derivative with respect to one of the thermodynamic variables of free energy is discontinuous. This is manifested in FeRh and MnAs by the fact that its magnetisation curve as a function of its temperature changes abruptly at its phase transition temperature, consequently the entropy change peak is intense and localised in temperature. A higher entropy change value is more suitable for a magnetic refrigeration application than in materials with a second-order phase transition. These types of materials are called giant magnetocaloric materials and are characterised by a large and temperature-localised entropy change, as shown in FIG. 2 where the absolute value of ΔS_{magn} is represented. FeRh has a so-called ‘inverse’ magnetocaloric effect because ΔS_{magn} is of positive value unlike the case of Gd and of MnAs where ΔS_{magn} is of negative value (referred to as a ‘direct’ magnetocaloric effect).

However, the entropy change peak as a function of temperature remains narrow, which also limits the cooling power of these materials with a first-order phase transition (MnAs and FeRh given as examples).

Ultimately, the ideal material for applications should have a high magnetic cooling power and is characterised by a curve of magnetic entropy change as a function of its temperature having high values in a relatively wide temperature range.

To meet these two conditions, it has been proposed to form a magnetocaloric composite product by assembling several first-order magnetic phase transition materials, in particular in the following documents:
J. A. Barclay et al., Active magnetic regenerator. 1982, U.S. Pat. No. 4,332,135,
C. Muller et al., Magnetocaloric element. 2014,
Document U.S. Pat. No. 8,683,815,
A. Rowe et al., Int. J. Refrig. 29, 1286-1293 (2006), L. T. Kuhn et al., J. Phys. CS 303, 012082 (2011),
N. H. Dung et al., Adv. Energy Mater. 1, 1215-1219 (2011),
K. K. Nielsen et al., Int. J. Refrig. 34, 603-616 (2011),
S. Özcan et al., Multi-material-blade for active regenerative magneto-caloric or electro-caloric heat engines. 2013 Document EP2541167A2,
C. M. Hsieh et al., IEEE Transactions on Magnetics 50, 1-4 (2014),
R. Bulatova et al., International Journal of Applied Ceramic Technology 12, 891-898 (2015),
C. Carroll et al., Performance improvement of magnetocaloric cascades through optimized material arrangement. 2016 Document US20160109164.

The assembled materials have different magnetic phase transition temperatures. The composite product resulting from an assembly can then perform several thermal cycles around different temperatures, allowing the gap between T_{H} and T_{L} to widen as shown in FIGS. 3 and 4. The entropy change curve of this composite product can be seen as the superposition of the entropy change curves of the materials of which it is composed. As can be seen in FIG. 4, this superposition of curves reaches high values over a wide temperature range.

However, the assembly of these different materials is complex to implement, so the manufacturing cost of the composite product is high, and if this assembly is not perfect, the product's performance may be degraded.

### DISCLOSURE OF THE INVENTION

One of the aims of the invention is to obtain a low-cost, high-cooling-power magnetocaloric product.

Proposed, therefore, according to a first aspect, is a method for obtaining a magnetocaloric product from a single piece of material having a magnetic phase transition, the method comprising irradiation of at least part of the material with ions, the irradiation being conducted with a fluence adapted so that the material has, after irradiation, different magnetic phase transition temperatures in different parts of the material.

The method proposed here cleverly takes advantage of a known phenomenon, according to which an irradiation of ions within a material induces a shift in the magnetic phase transition temperature of the material which depends on the fluence used during the irradiation. By varying the ion irradiation fluence in different parts of the material, a product with magnetocaloric effect at several magnetic phase transition temperatures is obtained from a single piece of material. The disadvantages of the solution of assembling several magnetocaloric materials to obtain a composite product with several magnetic phase transition temperatures are therefore overcome by the proposed method.

The method according to this first aspect of the invention may include the following features or steps, taken alone or in combination where technically possible.

The single piece of material has a first-order magnetic phase transition.

The fluence is adapted so that the magnetic phase transition temperature of the material varies by at least 0.5 kelvin between two different parts of the material.

The fluence is adapted so that the material has, after irradiation, a maximum difference in the magnetic phase transition temperatures of the different parts of the product of value within the range of 0.5 to 150 kelvins.

The fluence is adapted so that the magnetic phase transition temperature of the material varies, after irradiation, monotonously from a first part of the material to a second part of the material.

The fluence is adapted so that the magnetic phase transition temperature of the material varies, after irradiation, continuously from a first part of the material to a second part of the material.

The material is made of iron-rhodium.

Further proposed, according to a second aspect, is a magnetocaloric product obtainable by the method according to the first aspect of the invention.

Further proposed, according to a third aspect, is a method for implementing a thermal cycle involving subjecting a product according to the second aspect of the invention to a variable magnetic field so that the different magnetic phase transition temperatures in different parts of the material are crossed during the thermal cycle.

Further proposed, according to a fourth aspect, is a heat engine configured to implement a thermal cycle, the engine comprising:
a magnetocaloric product according to the second aspect of the invention,
means for subjecting the product to a variable magnetic field so that the different magnetic phase transition temperatures in different parts of the material are crossed during the thermal cycle.

The heat engine is for example a heat pump, a refrigerator, a thermoelectric generator or an active magnetic generator.

### DESCRIPTION OF THE FIGURES

Other features, aims and advantages of the invention will emerge from the following description, which is purely illustrative and not limiting, and which must be read in conjunction with the appended drawings wherein:

FIG. 1 shows an Ericsson thermal cycle implemented by a heat engine comprising a magnetocaloric material.

FIG. 2 shows two curves of the absolute value of the entropy change |ΔS_{magn}| within three materials as a function of their temperature, for an applied magnetic field change of 0 to 2 tesla.

FIG. 3 shows a set of curves of entropy change within different materials assembled within a product known from the state of the art, as a function of their temperature.

FIG. 4 shows a set of Ericsson thermal cycles implemented by a heat engine comprising a plurality of magnetocaloric materials.

FIG. 5 is a cross-sectional view of a magnetocaloric product, according to an embodiment.

FIG. 6 shows the atoms of a material in an antiferromagnetic phase and in a ferromagnetic phase.

FIG. 7 shows two curves of FeRh entropy change as a function of its temperature, depending on whether the material is irradiated or not.

FIGS. 8, 9 and 10 are three curves of spatial distribution of magnetic phase transition temperature within magnetocaloric products, according to three different embodiments.

FIG. 11 is a schematic cross-sectional view of a refrigerator according to an embodiment.

On all figures, similar elements have the same reference signs.

### DETAILED DESCRIPTION OF THE INVENTION

Process for Obtaining a Magnetocaloric Product

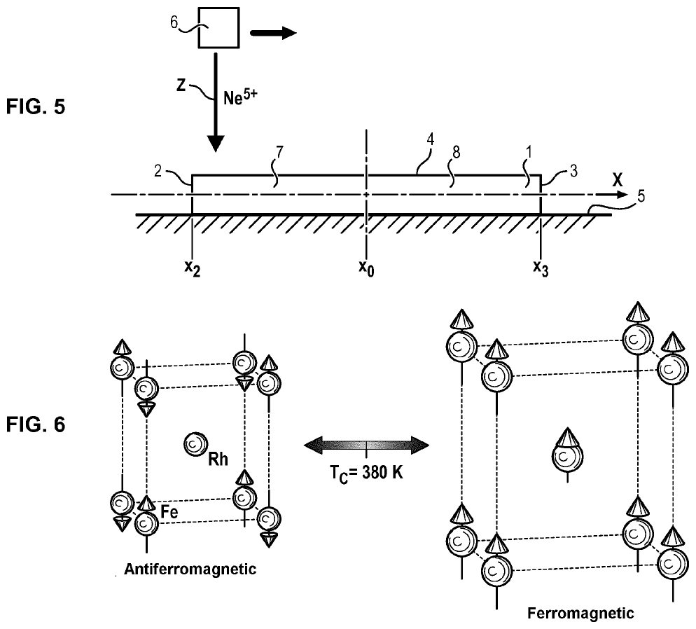

With reference to FIG. 5, a material 1 extends along an axis X. This material 1 has a first edge 2 and a second edge 3 opposite the first edge 2. The two edges 2, 3 have different positions along the axis X (respectively x2 and x3).

The material 1 has a free surface 4 connecting the first edge 2 to the second edge 3. The free surface 4 is for example flat and parallel to the axis X.

The material 1 is a single piece. ‘Single piece of material’ means a single piece of material, with a continuous structure, from a single block. In particular, the material has an identical phase transition temperature at any point in its structure, particularly regardless of its position along the axis X.

The material 1 is also first-order magnetic phase transition material. Consequently, the entropy change curve of this material 1 as a function of its temperature has a high peak value in its magnetic phase transition temperature.

The following is a non-limiting example of a material 1 made of an iron-rhodium (FeRh)-based alloy.

The material 1 will have a composition of type FeₓRh₁₋ₓ with a value of x close to 0.5, comprising about 50% iron and about 50% rhodium by atomic weight.

The material 1 is single crystal.

With reference to FIG. 6, at low temperature, iron-rhodium is antiferromagnetic. In this phase, iron atoms have parallel spins, but in opposite directions. More precisely, in this phase, iron-rhodium has a simple cubic configuration (CsCl type): each rhodium atom is at the centre of a cube. At each vertex of the cube, there is a pair of iron atoms with opposite direction spins.

At higher temperatures, iron-rhodium is ferromagnetic. In this phase, iron-rhodium always has a cubic configuration.

As shown in FIG. 2, iron-rhodium has a magnetic phase transition temperature from the antiferromagnetic phase to the ferromagnetic phase (or vice versa) of about 380 kelvins.

The material 1 is placed on a substrate 5, for example an MgO substrate.

An ion source 6 is used to irradiate the material 1 with ions, for example parallel to an irradiation direction Z.

For example, the ion source used is the product ‘Supernanogan’ marketed by Pantechnik.

The ions projected into the material 1 induce a shift in the magnetic phase transition temperature of the material 1 to a lower value. This phenomenon, known per se, is described in the document ‘Effects of energetic heavy ion irradiation on the structure and magnetic properties of FeRh thin films’, by Nao Fujita et al., Nucl. Instrum. Methods B 267, 921-924 (2009).

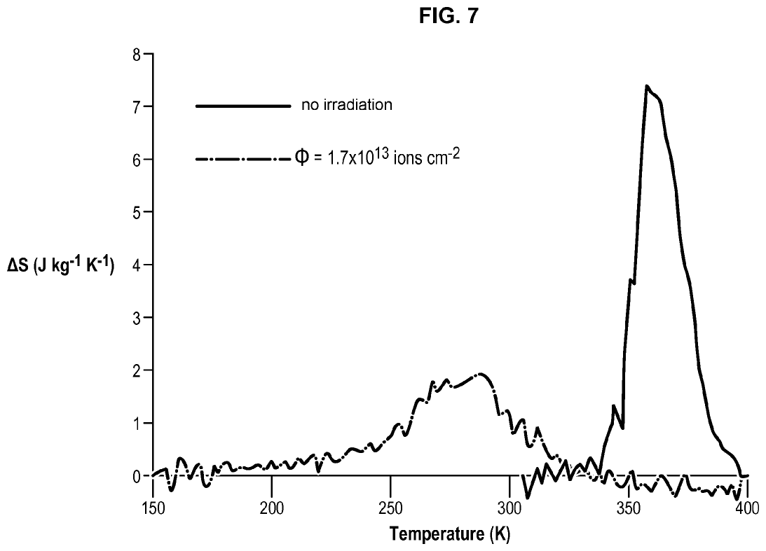

The phase transition temperature shift depends on the fluence used during ion irradiation, i.e. the number of ions irradiated in the material 1 per cm². FIG. 7 shows, by way of example, two curves of FeRh entropy change as a function of its temperature: a reference curve for unirradiated FeRh, and a second relative curve for FeRh irradiated with Ne⁵⁺ ions with an incidence angle of 60° and a kinetic energy of 25 keV and a fluence of 1.7×10¹³ ions/cm².

The proportionality coefficient between fluence and temperature shift is about −5.10⁻¹² K/(ions/cm²) under these irradiation conditions. This coefficient depends on the irradiation conditions, particularly the type of ion, its kinetic energy, the angle of incidence and the intrinsic properties of the material.

The fluence depends on the ion emission parameters of the ion source used. These parameters, well known to the skilled person, include in particular the number of ions impacting the material per unit time and surface area and the irradiation time. By way of example, the above-mentioned conditions produce a fluence between 10¹² and 10¹⁵ ions/cm² on a material 1.

In this case, the kinetic energy of the ions is adjusted (and/or the angle of incidence of the ion beam) to a value suitable for the ions to penetrate the material 1 and possibly to exit it.

Preferably, the ions used are heavy ions because they generate collisions and defects more efficiently within the irradiated material. It is this number of defects that determines the value of the previously defined proportionality coefficient. The advantage of heavy ions is that they only require irradiation of the material 1 over a relatively short irradiation period to change the phase transition temperature of a given deviation. The energy of the ions must be high enough to penetrate the material. There is no limit on the maximum energy because ions can also pass through the material even if the proportionality coefficient between fluence and temperature shift will depend on it.

The ions are for example neon ions, typically Ne⁵⁺.

In an unconventional way, the irradiation of the material 1 with the ions emitted by the ion source 6 is conducted with spatially variable fluence. In other words, the fluence is adapted so that the material 1 has, after irradiation, different magnetic phase transition temperatures in different parts of the material 1.

Returning to FIG. 5, the ion source 6 is moved and/or oriented relative to the material 1 so that the ions projected by the source scan the free surface 4 of the material 1 from the first edge 2 to the second edge 3 opposite the first edge 2. The scanning direction is for example parallel to the axis X.

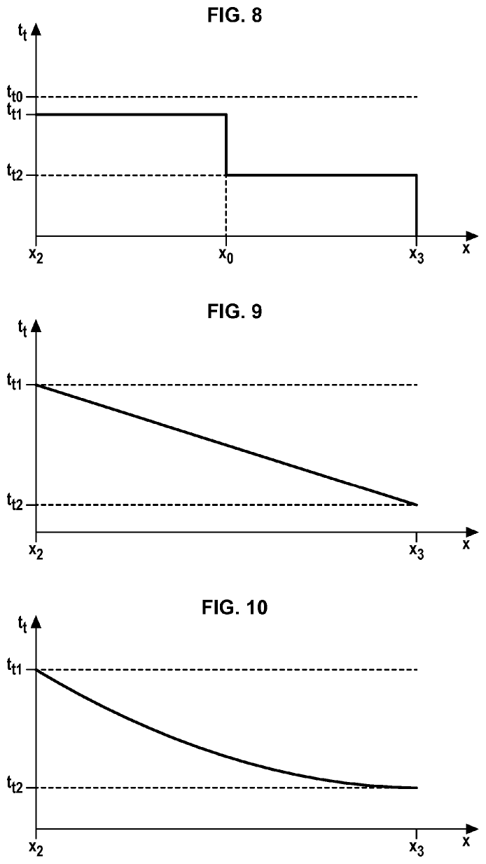

The emission parameters of the ion source are adjusted so that the ion fluence in the material 1 varies monotonously during this scanning (increasing or decreasing). FIGS. 8 to 10 show different phase transition temperature spatial profiles (from the antiferromagnetic phase to the ferromagnetic phase) obtainable by varying the fluence used during ion irradiation of the material 1.

The spatial profile shown in FIG. 8 can be obtained as follows. The emission parameters of the ion source are set to a first set of values, and the ion source scans a first part of the material 1 with this first set of parameter values. The first part extends from the first edge 2 of position x2 along the axis X to a position line x0 along the axis X, between positions x2 and x3. In this way, the ions emitted by the ion source penetrate into the first part of the material 1 at a first constant fluence. As a result, the magnetic phase transition temperature Tt0 of the material 1 (380 kelvins in the case of FeRh) shifts by a first deviation so that it is lowered to a first value Tt1. At the position of the line x0, the scanning is stopped. The emission parameters of the ion source are then modified and set to a second set of values different from the first set of values. The ion source scans a second part of the material 1 with this second set of parameter values. The second part extends from the position line x0 along the axis X to the second edge 3 of position x3. In this way, the ions emitted by the ion source penetrate into the second part of the material 1 at a second constant fluence different from the first fluence, for example larger. As a result, the magnetic phase transition temperature of the material 1 shifts by a second deviation so that it is lowered to a second value Tt2, lower than the first value Tt1.

In such an embodiment, the result is a curve of phase transition temperature within the material 1 as a function of the position along the axis X, which is continuous in pieces. At the end of this irradiation step, the material 1 comprises a first part 7 having a first magnetic phase transition temperature Tt1 and a second part 8 having a second phase transition temperature Tt2 different from (for example, lower than) the first magnetic phase transition temperature Tt1.

It is also possible to irradiate only part of the material 1. In this case, the magnetic phase transition temperature in the unirradiated part will not be modified. In this embodiment, it is also possible to obtain a curve of phase transition temperature within the material 1 as a function of the position along the axis X, which is continuous in pieces. Partial irradiation of the material can be achieved by using one or a series of masks of sufficient thickness to block the ions. The use of a mask has the advantage of very precise control of the edges of irradiated areas that can have complex geometries.

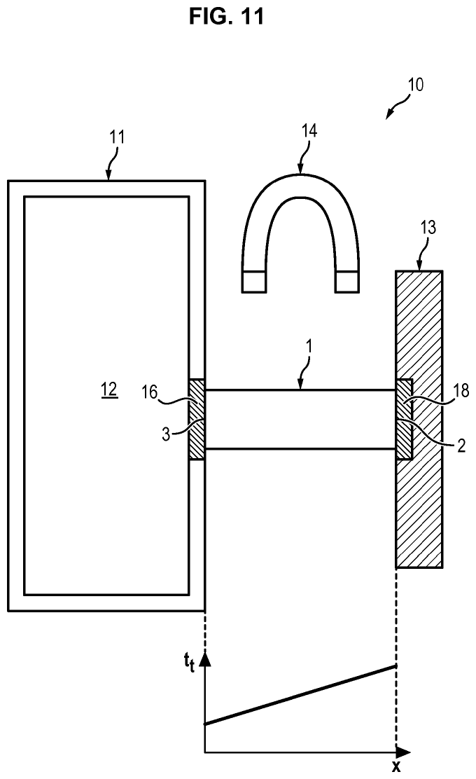

However, it is preferable to continuously vary the fluence of the irradiated ions in the material 1, from the first edge 2 to the second edge 3 of the material 1. This can be achieved by gradually varying the ion emission parameters during the scanning of the ion radiation emitted by the source from the first edge to the second edge or by varying the local average irradiation time. Consequently, the magnetic phase transition temperature obtained in the material 1, after irradiation, decreases or increases continuously within the material 1 as a function of the position along the axis X, for example linearly, as shown in FIG. 9, or non-linearly, as shown in FIG. 10.

Alternatively or complementarily, it is possible to spatially vary the transition temperature in the material 1 in a direction parallel to the direction of emission Z of the ions by the ion source 6. For this purpose, one or more ion irradiations are carried out with ions that penetrate more or less deeply into the material in the direction Z. By varying the energy of the emitted ions and/or their angle of incidence, a variable number of collisions, in the material 1 according to the direction Z, can be obtained.

A continuous magnetic phase transition temperature spatial variation within the obtained product is very advantageous because it increases the cooling power of the product. It is understood that, in both cases, the irradiated material 1 includes an infinite number of phase transition temperatures, the phase transition temperature being maximum in the position x2 (at the first edge 2) and minimum in the position x3 (at the second edge 3 opposite the first edge 2).

The fluence received in the material 1 is adapted so that the magnetic phase transition temperature of the material 1 varies, after irradiation, by a useful value and for example by at least 0.5 kelvin between two different parts of the material 1.

Furthermore, the ion fluence is adapted so that the material 1 has, after irradiation, a maximum difference in the magnetic phase transition temperatures of the different parts of the product of value within the range of a few kelvins (e.g. 2 kelvins) to about 150 kelvins.

The ion fluence is also adapted so that the material 1 has, after irradiation,
a minimum magnetic phase transition temperature within the range of 150 to 280 kelvins,
a maximum magnetic phase transition temperature ranging from 360 to 380 kelvins.

It should be noted that the single crystal character of the material 1 is advantageous because it allows more precise control of the desired phase transition temperature values in the material as a function of the ion emission parameters.

Once the irradiation is complete, a product with a giant magnetocaloric effect is obtained that can be used in a heat engine.

In general, the heat engine comprises the magnetocaloric product 1 obtained after irradiation, and means for subjecting the product to a variable magnetic field so that the different magnetic phase transition temperatures in different parts of the material are crossed during a thermal cycle implemented by the heat engine.

Magnetic Refrigeration

With reference to FIG. 11, illustrating a first application of the material 1, the heat engine is a refrigerator 10.

The refrigerator 10 has a storage element 11 defining an internal storage cavity 12, for example for storing foodstuffs. Instead of a storage cavity, another type of object can be cooled. This cavity 12 constitutes a cold source whose temperature must be maintained at a value T_{L}.

The refrigerator 10 also includes a radiator 13 in contact with an environment constituting a hot source at a temperature T_{H}.

The general function of the refrigerator 10 is to take heat from the cold source (the cavity) and supply it to the hot source via the radiator 13.

In the refrigerator 10, the magnetocaloric product 1 is arranged between the cavity 12 and the radiator 13. It is arranged to be in thermal communication with the cavity 12 and the radiator 13.

The refrigerator includes a first thermal switch 16 configurable in two configurations: a closed configuration, in which the first thermal switch 16 allows thermal communication between the product 1 and the cold source 12, and an open configuration, in which the thermal switch 16 prevents the product 1 and the cold source from being in thermal communication.

The first thermal switch 16 is typically located near the edge 3.

Similarly, the refrigerator 10 includes a second thermal switch 18 configurable in two configurations: a closed configuration, in which the second thermal switch 18 allows thermal communication between the product 1 and the radiator 13, and an open configuration, in which the thermal switch 18 prevents the product 1 and the radiator 13 from being in thermal communication.

The second thermal switch 18 is typically located near the edge 2.

The two thermal switches 16, 18 are synchronised to be closed and opened alternately (when one is open, the other is closed, and vice versa).

The refrigerator 10 also includes, as indicated above, means 14 of subjecting the product 1 to a variable magnetic field so that the different magnetic phase transition temperatures in different parts of the material are crossed during a thermal cycle implemented by the heat engine.

The means of subjection 14 include, for example, a magnet that is movable with respect to the product 1. During a thermal cycle implemented by the refrigerator, the magnet is moved closer and further away from the product 1 to take advantage of its magnetocaloric effect. Alternatively, the means 14 includes a magnetic field generator of variable intensity, for example an electromagnet subjected to a current of variable intensity. Alternatively, the product can be placed in a movable support with respect to one or more fixed magnets.

The product 1 is oriented so that the edge 2 is closer to the hot source 13 than the edge 3, and the edge 3 is closer to the cold source than the edge 2.

Of course, all the phase transition temperatures that can be found in the product 1 (two values Tt1 and Tt2 in the case of the profile in FIG. 8, and a continuous range of values between Tt1 and Tt2 in the case of the profiles in FIGS. 9 and 10) are higher than the target temperature T_{L} for the cavity 12, and lower than the temperature T_{H}.

The refrigerator 10 in FIG. 12 uses a magnetic refrigeration method comprising at least one thermal cycle.

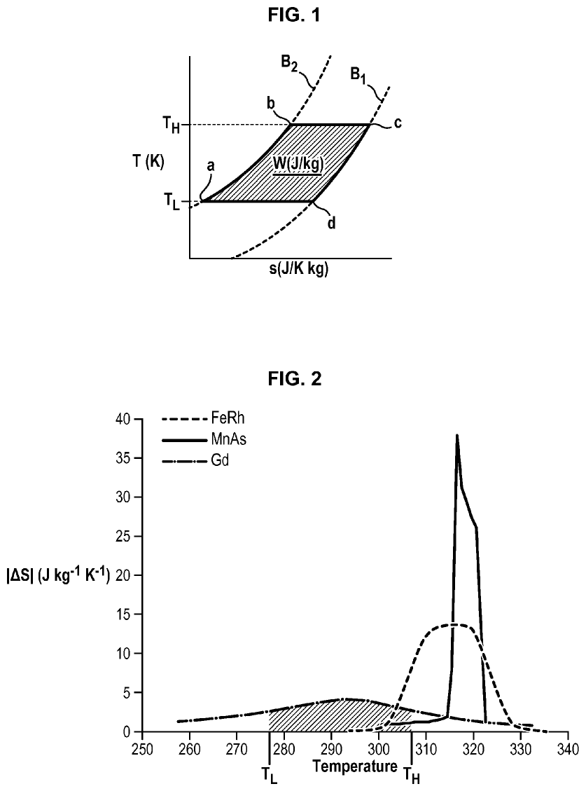

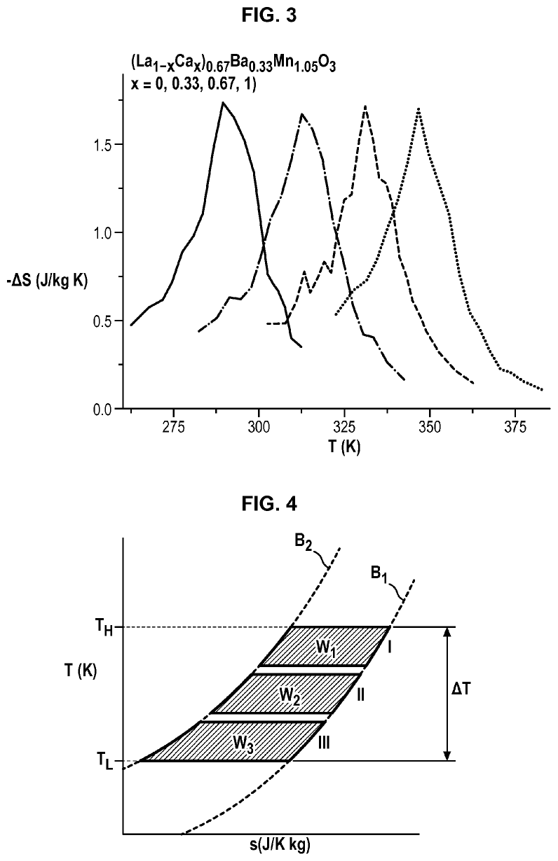

One possible thermal cycle is that of Ericsson, for example. It consists of four steps represented in FIG. 1, except that B1>B2 with B2=0 tesla. The method implemented by the refrigerator 10 comprises the following steps.

a) The product 1 is initially placed in thermal communication with cold source 12, by closing the first thermal switch 16. The product then cools to the temperature of the cold source T_{L}.

b) A magnetic field is applied to the product 1 that absorbs heat from the cold source 12 through the magnetocaloric (inverse) effect, which increases the entropy of the product 1.

c) The first thermal switch 16 is open, interrupting the thermal communication between the product and the cold source 12. In turn, the second thermal switch 18 is open, which puts the product 1 and the hot source 13 in thermal communication. The product 1 heats up and then takes the temperature T_{H} of the hot source 13.

d) The means of subjection 14 of the magnetic field are moved or reconfigured so that the product 1 ceases to be immersed in the magnetic field. The product 1 transfers its heat to the hot source 13 with the effect of reducing the entropy of the product 1.

a) The second thermal switch 18 is open, interrupting the thermal communication between the product and the hot source 13, and the first thermal switch 16 is closed. The product 1 then cools to the temperature of the cold source T_{L}. The product is then returned to the starting configuration of the cycle.

The efficiency of the cycle depends on the increase in the entropy change AS with respect to the variation in the magnetic field to which the product 1 is subjected, when the product is in contact with the hot and cold sources 12, 13. Ion irradiation treatment to have a temperature Tt1 close to T_{H} and Tt2 and close to T_{L} maximises the entropy changes AS associated with steps 1 and 3 and results in maximising the exchanged heat.

The thermal cycle used is for example of the same type as that shown in FIG. 4. Other thermal cycles are possible, such as the Brayton cycle with adiabatic transformations or the Carnot cycle.

Other Applications

With a small product, one possible application could be the cooling of microelectronic components. In this case it is possible that the different components of the device described in FIG. 12 may be manufactured by lithography or other microelectronic techniques where the storage cavity 11 is substituted by an electronic element (power diode, micromethodor, etc.) to be cooled. In another application, the irradiated material 1 is used as a magnetocaloric product in a heat pump. The skilled person could, for example, start from the heat pump described in U.S. Pat. No. 8,763,407 or EP2541167A2 or U.S. Pat. No. 2,589,775 and replace the magnetocaloric composite product suggested in this document with the ion-irradiated material 1, which is a single piece.

In yet another application, the irradiated material 1 is used as a magnetocaloric product in a thermoelectric generator to produce electrical energy. The skilled person could, for example, start from a thermoelectric generator described in document U.S. Pat. Nos. 428,057 or 2,016,100 or 2,510,800, or from an active magnetic generator described in document U.S. Pat. No. 4,332,135, and replace the magnetocaloric composite product suggested in this document with the ion-irradiated material 1, which is a single piece.

The invention is not limited exclusively to FeRh. Other first-order magnetic phase transition materials can be used instead of FeRh. More specifically, any material that changes its transition temperature when irradiated with ions can be used instead of FeRh.

1. Method for obtaining a magnetocaloric product from a single piece of material having a magnetic phase transition, the method comprising irradiating at least part of the material with ions, wherein said irradiating is conducted with a fluence adapted so that the material has, after said irradiating, different magnetic phase transition temperatures in different parts of the material.

2. Method according to claim 1, wherein the single piece of material has a first-order magnetic phase transition.

3. Method according to claim 1, wherein the fluence is adapted so that the magnetic phase transition temperature of the material varies by at least 0.5 kelvin between two different parts of the material.

4. Method according to claim 1, wherein the fluence is adapted so that the material has, after said irradiating, a maximum difference in the magnetic phase transition temperatures of the different parts of the product of value within the range of 0.5 to 150 kelvins.

5. Method according to claim 1, wherein the fluence is adapted so that the magnetic phase transition temperature of the material varies, after said irradiating, monotonously from a first part of the material to a second part of the material.

6. Method according to claim 1, wherein the fluence is adapted so that the magnetic phase transition temperature of the material varies, after said irradiating, continuously from a first part of the material to a second part of the material.

7. Method according to claim 1, wherein the material consists of iron-rhodium.

8. Magnetocaloric product obtainable by the method according to claim 1.

9. Method for implementing a thermal cycle, said method comprising subjecting a product according to claim 8 to a variable magnetic field so that different magnetic phase transition temperatures in different parts of the material are crossed during the thermal cycle.

10. Heat engine configured to implement a thermal cycle, the heat engine comprising:
a magnetocaloric product according to claim 8,
means for subjecting the product to a variable magnetic field so that the different magnetic phase transition temperatures in different parts of the material are crossed during the thermal cycle.

11. Heat engine according to claim 10, wherein the heat engine is a heat pump or a refrigerator or a thermoelectric generator or an active magnetic generator.
